(19) United States
(12) Patent Application Publication
(10) Pub. No.: US 2015/0254039 A1
(43) Pub. Date: Sep. 10, 2015

(54) INFORMATION PROCESSING SYSTEM, INFORMATION PROCESSING METHOD, AND COMPUTER-READABLE MEDIUM

(71) Applicant: FUJI XEROX CO., LTD, Tokyo (JP)

(72) Inventor: Yuji YONEDA, Kanagawa (JP)

(73) Assignee: FUJI XEROX CO., LTD, Tokyo (JP)

(21) Appl. No.: 14/478,852

(22) Filed: Sep. 5, 2014

(30) Foreign Application Priority Data
Mar. 5, 2014 (JP) 2014-042313

(51) Int. Cl. G06F 3/12

(52) U.S. Cl. CPC G06F 3/1246; G06F 3/1265; G06F 3/1268; G06F 3/1292; G06F 3/1289

(57) ABSTRACT

An information processing system includes a display-information specification information acquiring unit, a request signal generating unit, a second-display-file acquiring unit, and a print data output unit. The display-information specification information acquiring unit acquires display-information specification information for specifying display information displayed on a terminal transmitting a print instruction. On a basis of the display-information specification information, the request signal generating unit generates a request signal for requesting a second display file which is different from a first display file used for the display on the terminal and which corresponds to the display information. The second-display-file acquiring unit acquires the second display file on a basis of the request signal. The print data output unit outputs print data generated from the second display file to a printer.

### CROSS-REFERENCE TO RELATED APPLICATIONS

This application is based on and claims priority under 35 USC 119 from Japanese Patent Application No. 2014-042313 filed Mar. 5, 2014.

### BACKGROUND

### Technical Field

The present invention relates to an information processing system, an information processing method, and a computer-readable medium.

### SUMMARY

According to an aspect of the invention, there is provided an information processing system including a display-information specification information acquiring unit, a request signal generating unit, a second-display-file acquiring unit, and a print data output unit. The display-information specification information acquiring unit acquires display-information specification information for specifying display information displayed on a terminal transmitting a print instruction. On a basis of the display-information specification information, the request signal generating unit generates a request signal for requesting a second display file which is different from a first display file used for the display on the terminal and which corresponds to the display information. The second-display-file acquiring unit acquires the second display file on a basis of the request signal. The print data output unit outputs print data generated from the second display file to a printer.

### BRIEF DESCRIPTION OF THE DRAWINGS

Exemplary embodiments of the present invention will be described in detail based on the following figures, wherein:

FIG. 1 is a diagram illustrating an information processing system according to an exemplary embodiment of the present invention;

FIG. 2 is a diagram illustrating the configuration of a print server according to the exemplary embodiment;

FIG. 3 is a diagram illustrating an exemplary first home page displayed on the display unit of a portable terminal;

FIG. 4 is a diagram illustrating an exemplary second home page; and

FIG. 5 is a flowchart of a process performed in the information processing system according to the exemplary embodiment of the present invention.

### DETAILED DESCRIPTION

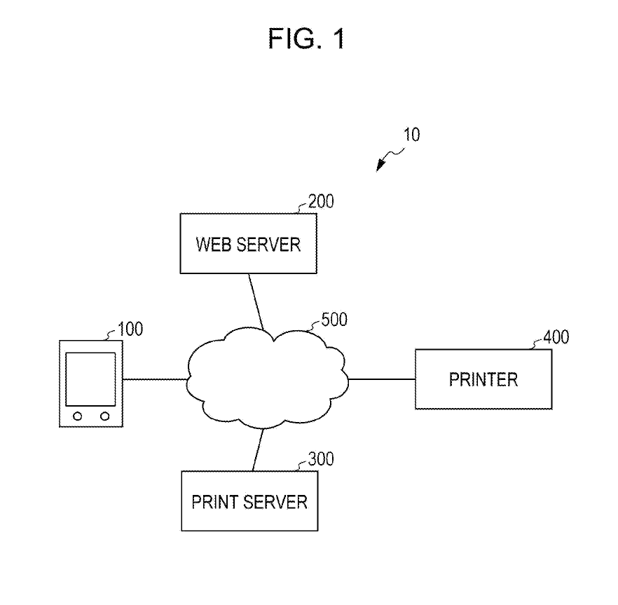

FIG. 1 is a diagram illustrating an information processing system 10 according to an exemplary embodiment of the present invention. The information processing system 10 includes a portable terminal 100, a web server 200, a print server 300, and a printer 400 which are connected to each other via a network 500.

In the information processing system 10, in response to a print instruction which requests that a home page displayed on the portable terminal 100 be printed and which is transmitted from the portable terminal 100, the print server 300 obtains a display file (second display file) which corresponds to the home page and which is different from a display file (first display file) used for display of the home page on the portable terminal 100, and print data based on the second display file is printed at the printer 400. The first display file is a display file for displaying a home page on a small portable terminal such as a portable terminal 100, while the second display file is a display file for displaying a home page on a fixed terminal such as a personal computer. The first display file and the second display file are Hypertext Markup Language (HTML) files stored, for example, in the web server 200.

The portable terminal 100 is a portable terminal including a display unit, such as a smartphone. In the present exemplary embodiment, the portable terminal 100 transmits a display-file request signal for requesting a display file for displaying a home page to the web server 200, and transmits a print instruction to print a home page to the print server 300.

The web server 200 is an information processing apparatus which, on the basis of a display-file request signal transmitted from the portable terminal 100 or the print server 300, transmits a display file that is used to display a home page and that is specified by the display-file request signal, to the portable terminal 100 or the print server 300.

The print server 300 is an information processing apparatus which transmits a second-display-file request signal for requesting a second display file to the web server 200 on the basis of the print instruction transmitted from the portable terminal 100, generates print data on the basis of the second display file transmitted in response to the second-display-file request signal, and transmits the generated print data to the portable terminal 100 and the printer 400.

The printer 400 is a typical printer which performs printing on the basis of the print data transmitted from the print server 300.

The present exemplary embodiment will be described in detail below. The portable terminal 100 obtains a display file (first display file) from the web server 200 in accordance with a user operation, and displays a home page (first home page) on the basis of the first display file on the display unit of the portable terminal 100.

When the user of the portable terminal 100 is to print the content of the first home page displayed on the display unit, the user performs a predetermined print operation on the portable terminal 100.

The portable terminal 100 transmits a print instruction to the print server 300 in accordance with the print operation performed by the user. The print instruction includes an Internet address, i.e., a uniform resource locator (URL), which is used to obtain a first display file for displaying a first home page on the display unit of the portable terminal 100.

On the basis of first print data for printing a first home page and second print data for printing a second home page described below, which are transmitted from the print server 300 in response to the print instruction, the portable terminal 100 displays the print image of the first print data and that of the second print data on the display unit, and receives a specifying operation of specifying which is to be printed among the first home page and the second home page. The portable terminal 100 transmits print-data specification information representing the result of the specifying operation to the print server 300. When the second home page is not present, the print server 300 transmits only first print data, and the portable terminal 100 displays the print image of the first print data. The user performs an operation indicating that the print image is confirmed, and the portable terminal 100 transmits a print-image confirmation signal to the print server 300.

In response to the signal which requests a display file for displaying a home page and which is transmitted from the portable terminal 100 or the print server 300, the web server 200 transmits the display file to the portable terminal 100 or the print server 300. When the requested display file is not present, the web server 200 transmits a signal indicating a notification about this.

On the basis of a signal transmitted from the portable terminal 100, the print server 300, for example, obtains a display file, generates print data, and outputs the print data. The configuration of the print server 300 will be described below in detail.

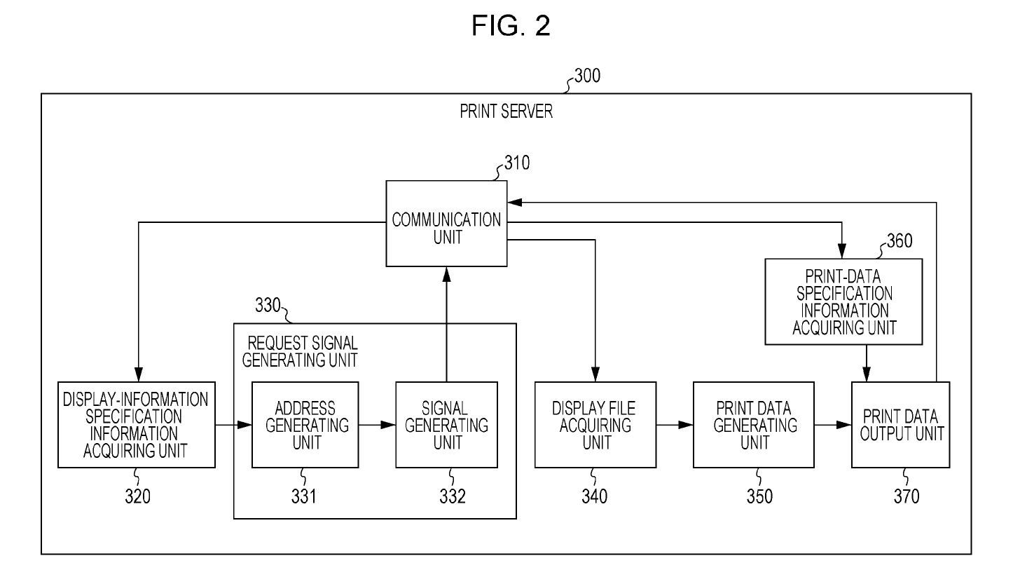

FIG. 2 is a diagram illustrating the configuration of the print server 300 according to the exemplary embodiment of the present invention. The print server 300 includes a communication unit 310, a display-information specification information acquiring unit 320, a request signal generating unit 330, a display file acquiring unit 340, a print data generating unit 350, a print-data specification information acquiring unit 360, and a print data output unit 370. The communication unit 310, the display-information specification information acquiring unit 320, the request signal generating unit 330, the display file acquiring unit 340, the print data generating unit 350, the print-data specification information acquiring unit 360, and the print data output unit 370 are implemented, for example, as a function of a central processing unit (CPU) which operates by using programs stored in a storage unit (not illustrated) of the print server 300.

The communication unit 310 transmits signals received from the units of the print server 300, via the network 500 to the portable terminal 100 or the like, and receives signals via the network 500 so as to output them to the units of the print server 300.

The display-information specification information acquiring unit 320 acquires display-information specification information for specifying a home page (display information or content) displayed on the portable terminal 100, from a print instruction which is transmitted from the portable terminal 100 and which is received by the communication unit 310. Specifically, the display-information specification information acquiring unit 320 acquires an Internet address (first address) of a display file (first display file) used to display a home page (first home page) displayed on the portable terminal 100, from a print instruction.

The request signal generating unit 330 generates a first-display-file request signal for requesting a first display file and a second-display-file request signal for requesting a display file (second display file) which corresponds to the display information displayed on the portable terminal 100 and which is different from the first display file used for display on the portable terminal 100, on the basis of the display-information specification information acquired by the display-information specification information acquiring unit 320, and outputs the generated signals to the communication unit 310.

The first-display-file request signal includes an identifier which uniquely specifies the first display file stored in the web server 200, and the second-display-file request signal includes an identifier which uniquely specifies the second display file stored in the web server 200.

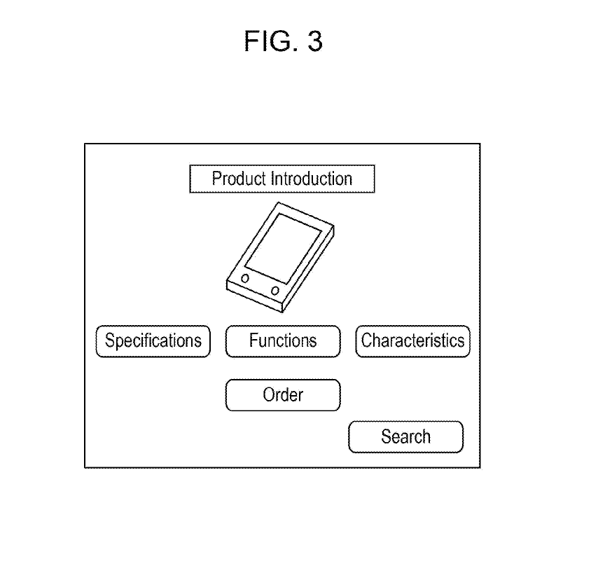

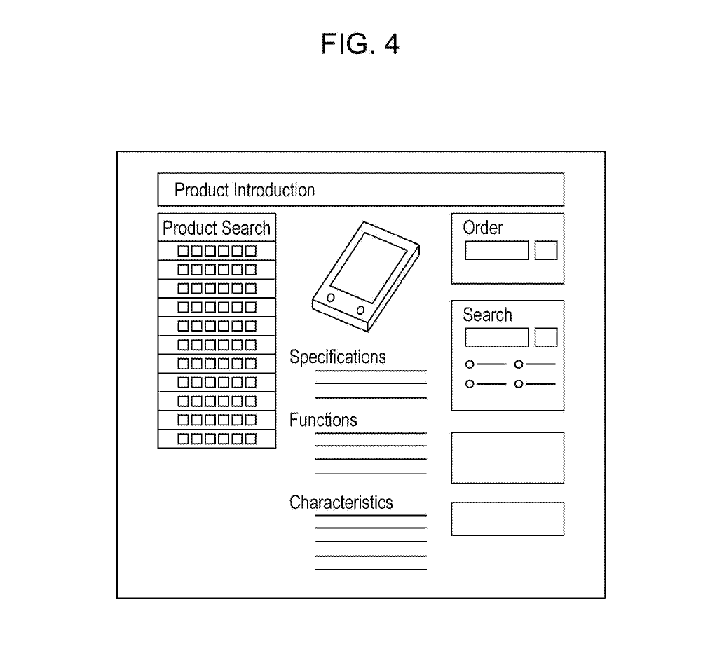

For example, the second display file is a display file for displaying a home page (second home page) having information similar to the first home page, on a fixed terminal such as a personal computer. That is, the first display file is a display file suitable for display on the portable terminal 100, and the second display file is a display file suitable for display on a fixed terminal. FIG. 3 is a diagram illustrating an exemplary first home page displayed on the display unit of the portable terminal 100. FIG. 4 is a diagram illustrating an exemplary second home page.

In the first home page which is assumed to be displayed on a smartphone or the like, buttons for operations on a touch panel are displayed on the display unit, and the size of characters displayed on the display unit is relatively large. In the first home page, the amount of image data may be reduced in consideration of a line speed or the like. The restriction on the screen size of a smartphone causes a small amount of information to be displayed on one screen. In contrast, in the second home page which is assumed to be displayed on a personal computer or the like, less buttons are displayed because information displayed by using buttons on the first home page is often displayed by using hyperlinks, and the size of displayed characters is relatively small. In addition, loose restriction on a line speed or the like in the second home page causes a relatively large amount of image data to be displayed. Further, loose restriction on the screen size causes a relatively large amount of information to be displayed on one screen. Thus, when the first home page is printed, buttons and the like which are not used on a print are printed; relatively large characters are printed; a relatively small amount of image is used; the amount of information per one page which is obtained through printing is relatively small; and the number of prints is relatively large. In contrast, when the second home page is printed, for example, less buttons are printed; relatively small characters are printed; a relatively large amount of image is used; the amount of information per one page which is obtained through printing is relatively large; and the number of prints is relatively small. That is, compared with a print of the first home page, a print of the second home page contains information which is more suitable for a print.

The request signal generating unit 330 includes an address generating unit 331 and a signal generating unit 332. The address generating unit 331 performs, for example, at least one of processes described below, thereby generating an Internet address (second address) of the second display file on the basis of the display-information specification information. That is, the address generating unit 331 searches characters in the first address acquired by the display-information specification information acquiring unit 320, replaces a string “mobile” contained in the first address with a string “pc”, and generates a second address. Alternatively, the address generating unit 331 obtains the first display file on the basis of the first address, performs an analysis process of searching the first display file for a predetermined string, such as “Move to a page for a personal computer” or “Move to a page for printing”, and extracts an address subsequent to the extracted string so as to generate a second address. The address generating unit 331 outputs the generated second address to the signal generating unit 332.

The signal generating unit 332 generates a second-display-file request signal for requesting a second display file from the web server 200 on the basis of the second address generated by the address generating unit 331, and outputs it to the communication unit 310. The signal generating unit 332 generates a first-display-file request signal for requesting a first display file from the web server 200 on the basis of the first address acquired by the display-information specification information acquiring unit 320, and outputs it to the communication unit 310. The communication unit 310 transmits the first-display-file request signal and the second-display-file request signal to the web server 200.

The display file acquiring unit 340 acquires a first display file and a second display file which are transmitted in response to the first-display-file request signal and the second-display-file request signal from the web server 200, and outputs them to the print data generating unit 350.

The print data generating unit 350 generates first print data for printing the first home page and second print data for printing the second home page, on the basis of the first display file and the second display file which are received from the display file acquiring unit 340. When the second display file is not present, the web server 200 transmits a notification about this to the print server 300, and the print data generating unit 350 generates only first print data. The data generated by the print data generating unit 350 is transmitted via the communication unit 310 to the portable terminal 100.

The print-data specification information acquiring unit 360 acquires print-data specification information which is transmitted from the portable terminal 100 and which specifies one of the first print data based on the first display file and the second print data based on the second display file as data to be printed at the printer 400. A user who has checked the first print data and the second print data which are displayed on the portable terminal 100 operates the portable terminal 100, whereby the print-data specification information is transmitted. The print-data specification information acquiring unit 360 outputs the print-data specification information to the print data output unit 370. When the second print data is not present, the print-data specification information acquiring unit 360 acquires a print-image confirmation signal instead of the print-data specification information, and outputs it to the print data output unit 370.

The print data output unit 370 outputs one of the first print data and the second print data which is specified by the print-data specification information received from the print-data specification information acquiring unit 360, to the communication unit 310. When the second display file is not present, the print data output unit 370 outputs the first print data to the communication unit 310 in response to the print-image confirmation signal received from the print-data specification information acquiring unit 360. The data which is output is transmitted by the communication unit 310 to the printer 400, and is printed at the printer 400.

Thus, in response to the print instruction from the portable terminal 100 on which the first home page is displayed, the second print data based on the second home page is generated and printed.

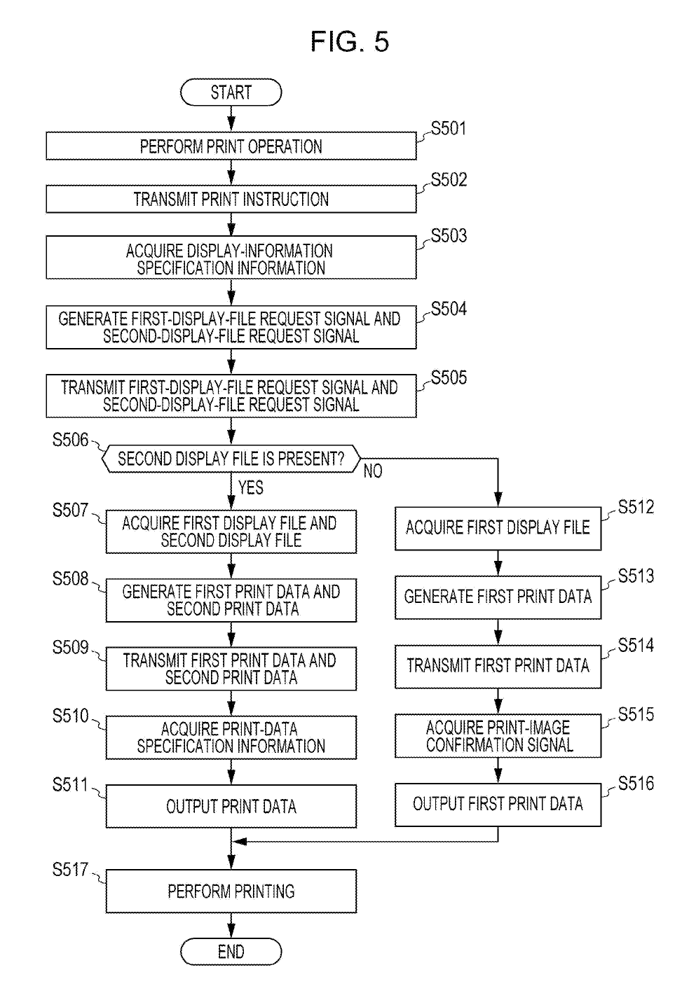

A process performed in the information processing system 10 according to the present exemplary embodiment will be described by using a flowchart. FIG. 5 is a flowchart of the process performed in the information processing system 10 according to the present exemplary embodiment of the present invention.

The user of the portable terminal 100 performs a print operation on the portable terminal 100 while a home page (first home page) to be printed is displayed on the display unit (S501).

The portable terminal 100 transmits a print instruction to the print server 300 in response to the print operation in S501 (S502).

When the print server 300 receives the print instruction transmitted in S502, the display-information specification information acquiring unit 320 of the print server 300 acquires display-information specification information specifying the home page (display information or content) displayed on the portable terminal 100, from the received print instruction (S503).

The request signal generating unit 330 of the print server 300 generates a first-display-file request signal for requesting a first display file and a second-display-file request signal for requesting a second display file on the basis of the display-information specification information acquired in S503 (S504).

The communication unit 310 of the print server 300 transmits the first-display-file request signal and the second-display-file request signal which are generated in S504 to the web server 200 (S505).

In response to the first-display-file request signal and the second-display-file request signal which are transmitted in S505, the web server 200 searches data accumulated in the web server 200 for the first display file and the second display file. If the second display file is present (S506), the web server 200 transmits the first display file and the second display file to the print server 300.

When the first display file and the second display file are transmitted from the web server 200, the display file acquiring unit 340 of the print server 300 acquires the first display file and the second display file (S507). The print data generating unit 350 generates first print data and second print data on the basis of the first display file and the second display file which are acquired (S508).

The print server 300 transmits the first print data and the second print data which are generated in S508 to the portable terminal 100 (S509).

The print image of the first print data and that of the second print data are displayed on the display unit of the portable terminal 100. The user of the portable terminal 100 specifies one of the first print data and the second print data as a target to be printed. The portable terminal 100 transmits print-data specification information indicating the result of the specifying operation to the print server 300.

The print-data specification information acquiring unit 360 of the print server 300 acquires the print-data specification information (S510), and the print data output unit 370 outputs the print data specified by the acquired print-data specification information to the printer 400 (S511).

If the second display file is not present in S506, the web server 200 transmits a notification about this, and transmits the first display file to the print server 300 so that the display file acquiring unit 340 of the print server 300 acquires the first display file (S512).

When the first display file is acquired in S512, the print data generating unit 350 of the print server 300 generates first print data on the basis of the first display file (S513).

The print server 300 transmits the first print data generated in S513 to the portable terminal 100 (S514).

The print image of the first print data is displayed on the display unit of the portable terminal 100. The user of the portable terminal 100 transmits a notification that the print image has been confirmed. The portable terminal 100 transmits a print-image confirmation signal to the print server 300.

The print-data specification information acquiring unit 360 of the print server 300 acquires the print-image confirmation signal (S515), and the print data output unit 370 outputs the first print data to the printer 400 in response to acquisition of the print-image confirmation signal (S516).

The print data which is output in S511 or S516 is transmitted via the communication unit 310 to the printer 400. The printer 400 prints the received print data (S517), and the process performed in the information processing system 10 according to the present exemplary embodiment ends.

The above-described configuration achieves the information processing system 10 in which print data based on a display file (source data) different from a display file used to display the display information (content) on the portable terminal 100 transmitting a print instruction is output to a printer.

The present invention encompasses a configuration obtained by modifying the above-described exemplary embodiment without departing from the gist of the exemplary embodiment, and is not limited to the above-described exemplary embodiment.

For example, in the above-described exemplary embodiment, the print server 300 transmits first print data and second print data to the portable terminal 100, and then receives print-data specification information. The present invention is not limited to this. For example, both of the first print data and the second print data may be printed. Alternatively, for example, predetermined settings and the like may be used to print the second print data without receiving print-data specification information. This configuration achieves an information processing system which performs printing without a specifying operation performed by the user of the portable terminal 100.

In the above-described exemplary embodiment, the portable terminal 100 transmits a print instruction including the address of a first display file. The print instruction which is transmitted may further include authentication information, such as an ID and a password, for displaying a first home page, and the signal generating unit 332 may generate a display-file request signal including the authentication information. Even when the first home page requires an ID and a password upon display, this configuration achieves acquisition of the first display file and the second display file which is performed by the display file acquiring unit 340 without an authentication error.

In the above-described exemplary embodiment, in response to reception of a print instruction from the portable terminal 100, the print server 300 obtains the first display file and the second display file. Alternatively, for example, the following configuration may be employed. After reception of a predetermined signal from the portable terminal 100, the display-information specification information acquiring unit 320 may acquire display-information specification information in accordance with display information on the portable terminal 100. The request signal generating unit 330 may generate a first-display-file request signal and a second-display-file request signal in response to the display-information specification information acquiring unit 320 acquiring the display-information specification information. The display file acquiring unit 340 may acquire and store the first display file and the second display file in response to the request signal generating unit 330 generating the first-display-file request signal and the second-display-file request signal. When a print instruction is transmitted from the portable terminal 100, the print data generating unit 350 may generate first print data and second print data based on the first display file and the second display file which correspond to the display information specified on the basis of the print instruction. According to this configuration, the first display files and the second display files may be obtained and stored without receiving a print instruction, and print data based on each of the display files may be generated. As a result, when a home page which changes as time goes, such as a bulletin board page, a home page for exchange rates, or a home page having a counter for the cumulative number of visitors, is to be printed, an effect that print data whose content is the same as that of a home page displayed on the portable terminal 100 is generated and printed may be achieved.

In the above-described exemplary embodiment, the first display file and the second display file are HTML files. These display files are stored in the web server 200, and the print server 300 transmits a display-file request signal including an identifier for specifying one of the display files, to the web server 200. The present invention is not limited to this. Another configuration may be employed in which the print server 300 transmits a request signal for grasping the display information (print image) of a first home page and a second home page. For example, the display file may be a file which is generated in the web server 200 on the basis of predetermined processing parameters and which contains the display information of a home page. The print server 300 may transmit processing parameters for generating a desired display file, as a display-file request signal. Alternatively, in a configuration in which the print server 300 transmits processing parameters for generating a display file, the web server 200 may transmit the processing parameters transmitted from the print server 300, to a second server, and the second server generates the display file. In this case, the display file may be transmitted from the second server to the print server 300, or may be obtained by the web server 200 so as to be transmitted from the web server 200 to the print server 300.

The operations which are performed by the web server 200, the print server 300, and the like and which are herein described are achieved by executing programs stored in the storage units corresponding to the servers. These programs may be provided through communication, or may be provided by storing them in a computer-readable storage medium such as a compact disc-read-only memory (CD-ROM).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a display-information specification information acquiring unit that acquires display-information specification information for specifying display information displayed on a terminal transmitting a print instruction;
a request signal generating unit that, on a basis of the display-information specification information, generates a request signal for requesting a second display file which is different from a first display file used for the display on the terminal and which corresponds to the display information;
a second-display-file acquiring unit that acquires the second display file on a basis of the request signal; and
a print data output unit that outputs print data generated from the second display file to a printer.

2. The information processing system according to claim 1,
wherein the display-information specification information acquiring unit acquires the display-information specification information from the print instruction which requests that the display information be printed and which is transmitted from the terminal.

3. The information processing system according to claim 1,
wherein the request signal generating unit includes
an address generating unit that generates an address for obtaining the second display file, on a basis of the display-information specification information.

4. The information processing system according to claim 2,
wherein the request signal generating unit includes
an address generating unit that generates an address for obtaining the second display file, on a basis of the display-information specification information.

5. The information processing system according to claim 3,
wherein the display-information specification information includes information representing an address of the first display file, and
wherein the address generating unit performs predetermined conversion on the address of the first display file, and generates an address for obtaining the second display file.

6. The information processing system according to claim 4,
wherein the display-information specification information includes information representing an address of the first display file, and
wherein the address generating unit performs predetermined conversion on the address of the first display file, and generates an address for obtaining the second display file.

7. The information processing system according to claim 3,
wherein the address generating unit analyzes the first display file obtained on a basis of the display-information specification information, and generates an address for obtaining the second display file.

8. The information processing system according to claim 4,
wherein the address generating unit analyzes the first display file obtained on a basis of the display-information specification information, and generates an address for obtaining the second display file.

9. The information processing system according to claim 1,
wherein, when the second-display-file acquiring unit fails to acquire the second display file, the print data output unit outputs print data based on the first display file.

10. The information processing system according to claim 1, further comprising:
a print-data specification information acquiring unit that acquires print-data specification information which is transmitted from the terminal and in which one of print data based on the first display file and the print data based on the second display file is specified as data to be printed at the printer,
wherein the print data output unit outputs one of the print data based on the first display file and the print data based on the second display file which is specified in the print-data specification information.

11. The information processing system according to claim 1,
wherein the request signal generating unit generates the request signal including authentication information which is used to display the display information and which is transmitted from the terminal.

12. The information processing system according to claim 1,
wherein the display-information specification information acquiring unit acquires the display-information specification information in accordance with the display information displayed on the terminal,
wherein the request signal generating unit generates the request signal in response to the display-information specification information acquiring unit acquiring the display-information specification information,
wherein the second-display-file acquiring unit acquires the second display file in response to the request signal generating unit generating the request signal, and
wherein, when the print instruction is transmitted from the terminal, the print data output unit outputs, as the print data based on the second display file, print data based on a second display file corresponding to the display information specified on a basis of the print instruction, among the second display files acquired by the second-display-file acquiring unit.

13. The information processing system according to claim 1,
wherein the first display file is a display file suitable for display on a portable terminal, and
wherein the second display file is a display file suitable for display on a fixed terminal.

14. The information processing system according to claim 1,
wherein the second display file is a display file being such that the number of prints obtained when the second display file is printed is less than the number of prints obtained when the first display file is printed.

15. The information processing system according to claim 1,
wherein the second display file is a display file being such that the amount of information per one page obtained when the second display file is printed is larger than the amount of information per one page obtained when the first display file is printed.

16. A non-transitory computer readable medium storing a program causing a computer to execute a process comprising:
acquiring display-information specification information for specifying display information displayed on a terminal transmitting a print instruction;
on a basis of the display-information specification information, generating a request signal for requesting a second display file which is different from a first display file used for the display on the terminal and which corresponds to the display information;
acquiring the second display file on a basis of the request signal; and
outputting print data generated from the second display file to a printer.

17. An information processing method comprising:
acquiring display-information specification information for specifying display information displayed on a terminal transmitting a print instruction;
on a basis of the display-information specification information, generating a request signal for requesting a second display file which is different from a first display file used for the display on the terminal and which corresponds to the display information;
acquiring the second display file on a basis of the request signal; and
outputting print data generated from the second display file to a printer.
